(19) United States
(12) Patent Application Publication
(10) Pub. No.: US 2011/0044881 A1
(43) Pub. Date: Feb. 24, 2011

(54) Method For The Catalytic Extraction Of Coal

(76) Inventors: Peter G. Stansberry, North Olmsted, OH (US); Ching-Feng Chang, Strongsville, OH (US)

Correspondence Address: GrafTech International Holdings, Inc., 12900 Snow Road, Parma, OH, 44130, US

(21) Appl. No.: 12/545,140

(22) Filed: Aug. 21, 2009

(51) Int. Cl. C01B 31/04; C10G 1/04

(52) U.S. Cl. 423/448; 208/435

(57) ABSTRACT

A method for the production of a carbon material from the extraction of coal, comprising forming a mixture of coal, a solvent and a catalyst selected from the group consisting of molybdenum, tin, titanium, zirconium, hafnium, thorium, selenium, tellurium, polonium, iron, cobalt, nickel, ruthenium, rhodium, palladium, osmium, iridium, platinum, the catalytically-active compounds and coordination compounds containing any of the foregoing, and combinations and mixtures thereof.

This invention was made with the support of the U.S. Department of Energy (DOE), under Award No. DE-FC26-03NT41874. The Government has certain rights in the invention. However, any opinions, findings, conclusions, or recommendations expressed herein are those of the Applicants and do not necessarily reflect the view of the DOE.

### BACKGROUND

1. Technical Field

The present invention relates to cokes useful for applications including the production of graphite electrodes, specialty graphite, or carbon anodes. More particularly, the present invention relates to a method for producing coke with a selected coefficient of thermal expansion (CTE) from solvent extracts of coal, to be used as a starting material for a graphite product which exhibits a desired coefficient of thermal expansion.

2. Background Art

Carbon electrodes, especially graphite electrodes, are used in the steel industry to melt both metals and supplemental ingredients used to form steel in electro-thermal furnaces. The heat needed to melt the substrate metal is generated by passing a current through at least one and, more commonly, a plurality of electrodes and forming an arc between the electrodes and the metal. Currents in excess of 100,000 amperes are often used. Likewise, carbon anodes are employed in aluminum smelting operations, and function to channel a current through the bauxite or other aluminum ore to a cathode bed.

The manufacture of graphite electrodes, as well as carbon anodes and specialty graphites, requires select calcined coke fillers and binders like pitch for efficient and economic operation. Normally, the coke filler is mixed with the binder, shaped, and baked to form a singular solid mass. Regular grade coke, or sponge coke, is suitable for carbon anodes in the aluminum industry and must meet certain requirements including low sulfur, ash, and metals content. Of particular concern is the presence of vanadium and nickel, which can act as oxidation catalysts. Since carbon anodes are consumed in the electrolytic rendering of aluminum metal, vast quantities of quality coke are needed on a global basis. Coke used in graphite electrodes has the additional requirement that long range order must be established. These cokes appear needle-like because of their highly crystalline nature. Although graphite electrodes are produced on a smaller scale than carbon anodes, they remain a critical commodity to the steel and other metals industry.

Graphite electrodes are typically manufactured using a needle coke filler combined with a pitch binder. Needle coke is a grade of coke having an acicular, anisotropic microstructure. The majority of the cokes currently used in the production of articles like graphite electrodes and carbon anodes are produced as a byproduct obtained by a delayed coking method in a petroleum refinery. Delayed coking can convert a variety of heavy petroleum fractions into distillate fuels by a thermal degradation mechanism, in which carbon is deposited on the internal cavity of the delayed coker. Although process conditions during the operation of the delayed coker can affect the quality of the coke, an important consideration is the chemical nature and constitution of the liquid feed. Only certain petroleum fractions will reliably produce desirable cokes. This is evidenced by the fact that only about one fourth of the coke produced in a delayed coker can be considered anode grade and a much smaller percentage considered needle grade.

Cokes that are highly oriented (or “anisotropic”), as required for graphite electrodes, are produced from highly aromatic oils of relatively low API gravity. These oils also tend toward higher coke yield than more aliphatic feedstocks.

For creating graphite electrodes that can withstand the desired ultra-high power throughput, the needle coke must have a low electrical resistivity and a low coefficient of thermal expansion (CTE) while also being able to produce a relatively high-strength article upon graphitization. The CTE value assigned to a needle coke is conventionally determined by admixing the milled, calcined coke with a pitch binder, extruding the coke/pitch blend to form an electrode, followed by heat treatment of the electrode to about 3000° C. to graphitize the electrode. The CTE value is then measured on the graphitized electrode.

The specific properties of the needle coke are determined predominately by the choice of feedstock and somewhat by the control of parameters in the coking method in which an appropriate carbon feedstock is converted into coke. Typically, the classification of needle coke is through a system of grade levels, which are distinguished as a function of the CTE over a certain temperature range. For example, premium needle coke is usually classified as having an average CTE of less than about 1.00×10⁻⁶/° C. over the temperature range of from about 100° C. to about 400° C. while regular grade needle coke has an average CTE of from about 1.00×10⁻⁶/° C. to about 1.25×10⁻⁶/° C. over the temperature range of from about 100° C. to about 400° C. The CTE value of the graphitized electrode produced with the coke filler is measured in the extruded (i.e., longitudinal) direction using either a dilatometer or the capacitance method as described in G. Wagoner et al., Carbon Conference 1986 Proceedings, pp. 234, Baden-Baden, 1986.

As noted, to convert the needle coke to graphite, the article containing the needle coke (e.g., the electrode) should be heated generally in a range of from about 2000° C. to about 3500° C. to convert the needle coke to a graphitic crystalline structure while eliminating volatilizing impurities. Such impurities negatively increase the CTE of a formed graphite electrode, and can result in electrode expansion as current is applied. The expansion will alter the arcing properties of the electrode either rendering the method less efficient or possibly resulting in electrode breakage.

Low CTE needle coke suitable for high performance graphite electrodes is largely produced from petroleum-derived feedstocks. For this purpose, the feedstock should be highly aromatic, provide a good carbon yield after coking, and be very low in ash and infusible solids. Typically in a production of petroleum needle coke, fluid catalytic cracking (FCC) decant oil is used as a starting material which contains about 0.02% to about 0.04% by weight of ash. The major constituent of ash is FCC catalyst remaining from the original cracking of the decant oil. This FCC catalyst increases the thermal expansion characteristics of a resulting electrode, thereby necessitating the removal of the catalyst for production of low CTE graphite electrodes from petroleum needle coke. As a result, many individuals have developed methods for removing the ash particles so as to decrease the CTE of the resulting electrode. For example, in U.S. Pat. No. 5,695,631, Eguchi et al. discloses a method for producing petroleum needle coke which includes filtration, centrifugation, and/or electrostatic aggregation to remove a substantial portion of the FCC catalyst from the decant oil.

While the use of petroleum-based needle coke can result in the formation of a graphite electrode with a lower CTE, there are significant disadvantages to using petroleum-based needle coke. One such disadvantage is the potential shortage of petroleum-derived needle coke as the price of petroleum continues to rise. Furthermore, there are few and limited suppliers of petroleum needle coke suitable for the creation of low CTE graphite electrodes. Additionally, the cost of petroleum needle coke is pushed even higher due to the required filtration to remove a significant portion of ash from the decant oil.

A different approach is to use coal-based feedstocks in providing needle coke for graphite electrodes. In this method, coal tar is derived from the coking method used to produce metallurgical coke from coal. The coal tar is obtained as the overhead product and contains infusible carbonaceous solids formed by gas-based carbonization and also as a result of coal carryover. These remaining solids interfere with the development of a large domain mesophase when forming needle coke and instead result in the formation of a high CTE coke.

Despite these solids, coal tar would be a desirable starting material for producing coke because coal tar is highly aromatic and has a high carbon yield. Coal tar generally has carbon yields of from about 10% to about 30% as determined by a modified Conradson carbon (MCC) test. However, in order to obtain a low CTE coke from coal tar, a physical solid separations method must be employed to remove undesirable solids which constitute up to 10% of the tar.

Examples in which solids have been removed from coal tar for the preparation of needle coke include Japanese Patent No. JP19850263700, Misao et al, in which quinoline-insoluble components are removed from coal tar and/or coal tar pitch for the use in delayed coking to produce needle coke.

In Masayoshi et al. (German Patent No. DE3347352), a method is described for producing needle coke in which a coal tar raw material is purified by hydrogenation in the presence of a hydrogenation catalyst until a denitrification ratio of at least 15% by weight is reached.

Rather than utilizing coal tar, methods have developed which utilize coal tar distillates to produce mesophase pitch. Lewis et al., U.S. Pat. No. 4,317,809, describe a method in which a coal tar distillate is heated under 750 psig for 5 hours at 450° C. to form a mesophase pitch. The overall yield of mesophase pitch is lower than desired, and the pressure utilized is considered too high for use in a commercial delayed coking method which generally operates below about 100 psig.

As described in U.S. Pat. No. 4,176,043, binder pitches can be prepared, in which a high-aromatic residual fraction from petroleum raw materials is mixed with a coal tar fraction in a weight ratio of 1:9 to 9:1, and heated. In a similar method, a cracking oil residue is mixed with coal tar pitch, after which the mixture is subjected to heat treatment at temperatures above 350° C. The cracking oil residue has a softening point of greater than 60° C., while the coal tar pitch has a softening point of greater than 80° C. During heating, the mixture is maintained in contact with a dehydrogenating agent.

Production of coke and pitch can also be accomplished using solvent extraction of coal, which encompasses a wide range of methods or techniques aimed toward bringing into solution a majority of the coal mass for the production of synthetic fuels. The method most relevant is variously called extractive chemical disintegration, solvent extraction of coal, or direct coal liquefaction. Under conditions above about 350° C. and in an appropriate solvent, coal can be converted into an oil or tar-like material suitable as a coke feedstock. Invariably, coal extraction requires that the carbon-to-hydrogen atomic ratio of the coal decrease, which can be accomplished by a variety of means. The more extensively coal is upgraded, the more it can appear pitch-like and the more anisotropic are the cokes derived therefrom.

What is desired, therefore, is a solvent extraction method for producing carbon materials, such as needle coke for low CTE graphite electrodes, other types of coke with a selected CTE, binder or impregnation pitch, including mesophase pitch, sponge coke, and carbon fibers, which provides greater efficiency, increased rates of production of the carbon materials and higher yields, from raw coal.

### BRIEF DESCRIPTION

The present disclosure provides a method which is uniquely capable of economically producing a desired carbon material, such as coke or pitch, by solvent extraction of coal. The disclosed method provides for a catalytic extraction, which provides greater efficiency, increased rates of production of the carbon materials and higher yields than heretofore observed. In one embodiment, the method produces a needle coke which resists expansion upon heating and, when incorporated into a graphite electrode or carbon anode, for instance, provides improved thermal stability and a reduced CTE.

More particularly, the method involves extraction from coal using a solvent such as an aromatic or hydroaromatic hydrocarbon, in the presence of a catalyst. Also, the solvent may be a non-aromatic hydrocarbon. Examples of suitable catalysts that increase the rate of dissolution of the coal into the solvent and which provides a measure of upgrading of the coal fragments can include compounds of molybdenum, iron and tin. Other suitable catalysts in the disclosed method include any of the metal elements of Group IVa of the Periodic Table: the elements of Group VIb of the Periodic Table chromium, molybdenum, and tungsten; and the elements of Group VIII of the Periodic Table: iron, cobalt, nickel, ruthenium, rhodium, palladium, osmium, iridium, and platinum; and elements of Group Ib and IIb such as copper and zinc. Also included in suitable catalysts are catalytically-active compounds and coordination compounds and any combination thereof containing any of the foregoing.

In the practice of the method of the present disclosure, coal is mixed with the solvent, in the presence of the catalyst. In one embodiment, the coal is milled or otherwise ground into particles to facilitate extraction. In a preferred embodiment, the coal should be in the form of particles having an average diameter such that at least 50% will pass through a 100 US mesh screen. In certain embodiments, at least 70% of the coal particles will pass through an 80 US mesh screen.

Generally, the amount of solvent and catalyst with which the coal extraction is effected may depend on the amount and size of the coal from which constituents are to be extracted and the processing equipment used to effect extraction. For instance, in some embodiments, the weight ratio of solvent to coal is about 1:1 to about 5:1. In a specific embodiment, the weight ratio of solvent to coal is about 1:1 to about 2:1; in other embodiments, the weight ratio of solvent to coal is about 2:1 to about 5:1. When the particle size of the coal is such that at least 70% of the coal particles will pass through an 80 US mesh screen, the weight ratio of solvent to coal need only be about 2:1 to about 5:1.

Likewise, the amount of catalyst employed should be that amount necessary to improve the extraction efficiency, rate of production or yield, and adequate level of upgrading, as compared to the method when employed without catalyst present. The weight ratio of catalyst to coal can be about 0.01:100 to about 5:100. Typically, the weight ratio of catalyst to coal is about 5:100 to about 1:100; in other embodiments, the weight ratio of catalyst to coal is about 0.1:100 to about 0.01:100.

In certain embodiments, the extraction in the presence of solvent and catalyst occurs under reaction conditions involving elevated temperatures, i.e., a temperature of at least about 325° C. Generally, the temperatures need not be higher than about 500° C. Also, in certain embodiments, the extraction is effected at atmospheric pressure; in other embodiments, the extraction is effected under elevated pressure, that is, pressures up to about 5000 psi (i.e., about 340 atmospheres).

In addition, the extraction reaction is, in certain embodiments, effected in a hydrogen atmosphere, or an inert atmosphere such as nitrogen.

Generally, the extraction method is performed for a period of at least about 0.5 hours; in the preferred embodiments, no more than about 1 hour is required for the extraction of a significant amount of the desired constituents from coal. In a certain example indeed, the presence of the catalyst provides for extraction of at least about 85%, more preferably up to about 90%, of the desired constituents (i.e., the extract itself) from the coal, in less than about 1 hour, more preferably less than about 0.5 hours.

An aspect of the disclosure, therefore, is a method for catalytic-mediated solvent extraction from coal.

Another aspect of the disclosure is a method for creating a carbon material like needle coke for low CTE graphite electrodes, binder or impregnation pitch, including mesophase pitch, sponge coke, and carbon fibers.

Still another aspect of the disclosure is a method for the catalytic extraction of coal which provides greater efficiency, increased rates of production, and upgrading of the carbon materials and higher yields.

Yet another aspect of the disclosure is a method for creating a coke having a selected CTE from coal.

Still another aspect of the disclosure is a method for creating a low CTE graphite electrode using a carbon material like needle coke and binder and/or impregnation pitch, using the disclosed method

These aspects, as well as others which will be familiar to the skilled artisan, that in one embodiment coke can be obtained by a method for the production of a carbon material from the extraction of coal which includes forming a mixture of coal, a solvent and a catalyst selected from the group consisting of vanadium, chromium, molybdenum, tungsten, iron, cobalt, nickel, copper, zinc, tin and the catalytically-active compounds and coordination compounds containing any of the foregoing, and combinations and mixtures thereof.

In yet another embodiment, these aspects, as well as others which will be familiar to the skilled artisan, can be obtained by a method including producing a coal extract from the catalytic extraction of coal by forming a mixture of coal, a solvent and a catalyst selected from the group consisting of molybdenum, tin, titanium, zirconium, hafnium, thorium, selenium, tellurium, polonium, iron, cobalt, nickel, ruthenium, rhodium, palladium, osmium, iridium, platinum, the catalytically-active compounds and coordination compounds containing any of the foregoing, and combinations and mixtures thereof; heating the coal extract under pressure to obtain raw coke; calcining the raw coke to create coke having a selected coefficient of thermal expansion; milling the coke; mixing the milled coke with coal tar binder pitch to create a mix; extruding the mix to form a green stock; baking the green stock to create a baked stock; and graphitizing the baked stock to create a graphite article having a selected coefficient of thermal expansion.

It is to be understood that both the foregoing general description and the following detailed description provide embodiments of the disclosure and are intended to provide an overview or framework of understanding to nature and character of the invention as it is claimed.

### DETAILED DESCRIPTION OF THE PREFERRED EMBODIMENTS

As noted above, in the practice of the method of the present disclosure, coal is mixed with a solvent, such as an aromatic, non-aromatic or hydroaromatic hydrocarbon, in the presence of the catalyst. The catalyst employed can include any of molybdenum, iron, tin, any of the transition metal elements of Group IVa of the Periodic Table, the main group elements of Group VIb of the Periodic Table, and the elements of Group VIII of the Periodic Table, as well as catalytically-active compounds and coordination compounds containing any of the foregoing. In a preferred embodiment, the catalyst is molybdenum.

In one embodiment, the coal is milled or otherwise ground into particles to facilitate extraction. In a preferred embodiment, the coal should be in the form of particles having an average diameter such that at least 50% will pass through a 100 US mesh screen. In certain embodiments, at least 70% of the coal particles will pass through an 80 US mesh screen. The amount of solvent and catalyst with which the coal extraction is effected may advantageously depend on the amount and size of the coal from which constituents are to be extracted and the processing equipment used to effect the extraction. For instance, in some embodiments, the weight ratio of solvent to coal is about 1:1 to about 2:1; in other embodiments, the weight ratio of solvent to coal is about 2:1 to about 5:1. When the particle size of the coal is such that at least 70% of the coal particles will pass through an 80 US mesh screen, the weight ratio of solvent to coal need only be about 2:1 to about 5:1. Likewise, the amount of catalyst employed should be that necessary to improve the extraction efficiency, rate of production or yield, as compared to the method when employed without catalyst present. Typically, the weight ratio of catalyst to coal is about 1:100 to about 5:100; in other embodiments, the weight ratio of catalyst to coal is about 0.1:100 to about 0.01:100.

The extraction in the presence of solvent and catalyst occurs under reaction conditions involving elevated temperatures, i.e., a temperature of about 325° C. to about 500° C. Also, the extraction is effected at a pressure between atmospheric pressure and about 5000 psi (i.e., about 340 atmospheres). The extraction atmosphere can be a hydrogen atmosphere, or an inert atmosphere such as nitrogen.

In some embodiments, the extraction method is performed for a period of at least about 0.5 hours; in the preferred embodiments, no more than about 1 hour is required for the extraction of a significant amount of the desired constituents from coal; indeed, the presence of the catalyst provides for extraction of at least about 85% of the desired constituents from the coal, in less than about 1 hour.

After the extraction method, any elevated pressure and/or temperature to which the mixture was exposed is released; in addition, if the extraction is effected in other than air, the mixture is removed from the atmosphere. The resulting mixture is then subjected to a separation method, where the solids are separated from the liquid constituents of the mixture. This separation method can involve filtering by a suitable filter medium, settling, centrifugal separation, and the like. Indeed, the separation method can include more than one of the foregoing techniques.

Solvent and catalyst can be recovered after the separation method, and recycled or re-used.

The coal extract is a heavy hydrocarbon which can be used as a starting material for the creation of a carbon material having a select CTE. In certain embodiments, the first step is the selection of a coal extract with a relatively high initial boiling point. The boiling point of the coal extract may be greater than about 280° C. Furthermore, the relatively high boiling point coal extract should have a coking value of at least 1% as determined by an MCC. After selecting a relatively high boiling point coal extract, the coal extract undergoes a carbonization step in which both pressure and temperature are applied. The extract material is heated to a temperature of from about 450° C. to about 525° C. with the temperature preferably around 475° C. This temperature is achieved by heating the extract in a batch coking operation through a stepwise increase in the temperature of the coal extract at a rate of from about 35° C. per hour to about 65° C. per hour with the rate of temperature increase in one particular embodiment, preferably being at about 50° C. per hour. Once the aforementioned temperature of the extract material is achieved, the coal extract is maintained at that temperature for about 16 hours to about 25 hours in the coking vessel. Longer times may be needed at the lower specified temperatures to assure the conversion of the entire extract to coke. Alternatively, the coal extract can be fed continuously into a coking vessel maintained at a temperature of 450° C. to about 525° C. and then held at that temperature for at least 3 hours to complete the coking method.

The carbonization step results in the transformation of the coal extract material into a material which is referred to as either green coke or raw coke. This green coke has a black mass-like appearance with visible pores resulting from the evolution of volatile gases during the carbonization step. With this method, the yield of green coke is from about 50% to about 90% of the initial coal extract supplied for the carbonization step. After the carbonization and before the calcining step, the green coke can be crushed to increase the surface area of the coke and thereby decrease the necessary time for calcining.

The calcining step is conducted at a significantly higher temperature than the previous carbonization step. This step includes heating the crushed raw coke at a temperature of from about 1300° C. to about 1500° C., more preferably from about 1400° C. to about 1450° C. In this step, the hydrogen as well as a significant portion of the nitrogen and sulfur in the coke is removed and the coke is converted to a carbon structure. Furthermore, this set temperature is achieved in a batch operation through a step-wise increase in temperature of the raw coke at a rate of from about 300° C. per hour to about 400° C. per hour, in a particular embodiment ideally at a rate of about 350° C. per hour. For commercial operations, the raw coke can be fed continuously into a calciner where the temperature is raised in stages to reach the final value.

The resulting product is one having a select CTE which possesses properties making it well suited for the production of graphite products of choice. With the method of this disclosure, the yield of needle coke can be as high as about 95% of the raw coke produced by the carbonization step, and is generally at least about 80%, even 90%. The final production yield of the inventive method is of from about 50% to about 90% of the initial coal extract.

The coke having select CTE produced from the disclosed method can be utilized directly for certain applications or it can be used for the creation of a graphite product. The coke is first milled to produce particles and a flour, which is then hot mixed with of from about 15% to about 35% by weight of coal tar binder pitch. This mix is then extruded at a temperature of from about 90° C. to about 120° C. to form a green stock. By heating the hot mix of coal tar binder pitch and milled coke, the particles in the pitch melt causing the hot mixture to become fluid, and thus, susceptible to shaping by either extrusion, molding, or other formation techniques.

The green stock is then baked at a temperature of from about 800° C. to about 900° C. to carbonize the coal tar binder pitch element of the green stock. The baking of the green stock drives off volatile materials contained within the binder pitch material so that the resulting stock will have a more uniform internal structure.

The baked stock is then graphitized by heating to a temperature of from about 2600° C. to about 3400° C. with a preferred temperature of about 3000° C. The total graphitization time can be as short as a few hours or as long as several days depending upon both the size and application of the graphite article.

The resulting graphite article produced by this inventive method may have a desired CTE; in the case of an electrode, a relatively low CTE. Specifically, by using the capacitance method as described in G. Wagoner et al., Carbon Conference 1986 Proceedings, pp. 234, Baden-Baden, 1986, the electrode resulting from the inventive method will have a coefficient of thermal expansion of from about 0.005 ppm/° C. to about 0.150 ppm/° C.

As discussed above, the method can be practiced to produce carbon materials other than needle coke, such as carbon fibers, pitch, including binder pitch, impregnation pitch and/or mesophase pitch, and sponge coke, by variation of the foregoing method steps in a manner which would be familiar to the skilled artisan.

An advantage of the process described herein is that the yield of the conversion the coal extract into a pitch is up about 90%. Likewise the yield of such pitch into a coke is up to about 60%. In contrast the yield of coke from decant oil or coal tar distillate is only about 10 to 20%.

Accordingly, by the practice of the method of the present disclosure, carbon materials are prepared through a method including the catalytic extraction of coal, which provides greater efficiency, increased rates of production of the carbon materials and higher yields than conventional solvent extraction methods.

The disclosures of all cited patents and publications referred to in this application are incorporated herein by reference.

The above description is intended to enable the person skilled in the art to practice the invention. It is not intended to detail all the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention unless the context specifically indicates the contrary.

Thus, although there have been described particular embodiments of the present invention of a new and useful Method For The Catalytic Extraction Of Coal, it is not intended that such references be construed as limitations upon the scope of this invention except as set forth in the following claims.

What is claimed is:

1. A method for the production of a carbon material from the extraction of coal, comprising forming a mixture of coal, a solvent and a catalyst selected from the group consisting of molybdenum, tin, titanium, zirconium, hafnium, thorium, selenium, tellurium, polonium, iron, cobalt, nickel, ruthenium, rhodium, palladium, osmium, iridium, platinum, chromium, tungsten, copper, zinc, gold, silver, mercury, the catalytically-active compounds and coordination compounds containing any of the foregoing, and combinations and mixtures thereof.

2. The method of claim 1, wherein the carbon material comprises needle coke, sponge coke, mesophase pitch, binder pitch, impregnation pitch, carbon fibers, or combinations thereof.

3. The method of claim 1, wherein the solvent comprises one or more non-aromatic hydrocarbons, one or more aromatic hydrocarbons, or combinations thereof.

4. The method of claim 1, wherein the extraction is effected at a temperature of at least about 325° C.

5. The method of claim 4, wherein the extraction is effected at a temperature of about 325° C. to about 500° C.

6. The method of claim 1, wherein the extraction is effected under a pressure of up to about 5000 psi.

7. The method of claim 1, wherein the extraction is effected in an atmosphere of hydrogen or an inert gas.

8. The method of claim 1, wherein the ratio of solvent to coal is about 1:1 to about 5:1.

9. The method of claim 1, wherein the ratio of catalyst to coal is about 0.01:100 to about 5:100.

10. A method of producing a graphite product having a selected coefficient of thermal expansion, comprising:
(a) producing a coal extract from the catalytic extraction of coal by forming a mixture of coal, a solvent and a catalyst selected from the group consisting of molybdenum, tin, titanium, zirconium, hafnium, thorium, selenium, tellurium, polonium, iron, cobalt, nickel, ruthenium, rhodium, palladium, osmium, iridium, platinum, chromium, tungsten, copper, zinc, gold, silver, mercury, the catalytically-active compounds and coordination compounds containing any of the foregoing, and combinations and mixtures thereof;
(b) heating the coal extract under pressure to obtain raw coke;
(c) calcining the raw coke to create a coke having the selected coefficient of thermal expansion;
(d) milling the coke;
(e) mixing the milled coke with coal tar binder pitch to create a mix;
(f) extruding the mix to form a green stock;
(g) baking the green stock to create a baked stock; and
(h) graphitizing the baked stocked to create the graphite product with the selected coefficient of thermal expansion.

11. The method of claim 10, wherein the solvent of step (a) comprises one or more hydrocarbons.

12. The method of claim 10, wherein the extraction of step (a) is effected at a temperature of at least about 325° C.

13. The method of claim 12, wherein the extraction of step (a) is effected at a temperature of about 325° C. to about 500° C.

14. The method of claim 10, wherein the extraction of step (a) is effected under a pressure of up to about 5000 psi.

15. The method of claim 10, wherein the extraction of step (a) is effected in an atmosphere of hydrogen or an inert gas.

16. The method of claim 10, wherein the ratio of solvent to coal of step (a) is about 1:1 to about 5:1.

17. The method of claim 10, wherein the ratio of catalyst to coal of step (a) is about 0.01:1 to about 5:100.

18. A method of creating a graphite article having a selected coefficient of thermal expansion, comprising:
(a) forming a mixture of coal, a solvent and a catalyst selected from the group consisting of molybdenum, tin, titanium, zirconium, hafnium, thorium, selenium, tellurium, polonium, iron, cobalt, nickel, ruthenium, rhodium, palladium, osmium, iridium, platinum, chromium, tungsten, copper, zinc, gold, silver, mercury, the catalytically-active compounds and coordination compounds containing any of the foregoing, and combinations and mixtures thereof;
(b) extracting the mixture thereby forming a coal extraction; and
(c) heating the coal extract under pressure to obtain raw coke.

19. The method of claim 18, further comprising calcining the raw coke to create a coke having the selected coefficient of thermal expansion.

20. The method of claim 19, further comprising milling the coke.

21. The method of claim 18, further comprising mixing the milled coke with coal tar binder pitch to create a mix.

22. The method of claim 21, further comprising extruding the mix to form a green stock.

23. The method of claim 22 baking the green stock to create a baked article; and graphitizing the baked article to create the article having a selected coefficient of thermal expansion.
